(19) United States
(12) Patent Application Publication
(10) Pub. No.: US 2012/0010835 A1
(43) Pub. Date: Jan. 12, 2012

(54) INTRUSION DETECTION SYSTEM WITH SIGNAL RECOGNITION

(76) Inventors: Tor Sønsterød, Heggedal (NO); Jonathan James Burnard, New Glarus, WI (US)

(21) Appl. No.: 12/867,972

(22) PCT Filed: Jan. 30, 2009
(86) PCT No.: PCT/NO2009/000036

§ 371 Date: Jan. 24, 2011

(30) Foreign Application Priority Data
Feb. 22, 2008 (NO) 2008 0920

(51) Int. Cl. G08B 13/16; G06F 19/00

(52) U.S. Cl. 702/70

(57) ABSTRACT

An intrusion detection system comprises an intrusion detector, preferably a microphone for picking up infrasound, and a signal processor. Signals from the detector are split into two channels of different frequency ranges and processed separately in the two channels, and signal characteristics are compared between the two channels. Conclusions are drawn regarding the original signal source, on the basis of the comparison between the two channels.

### BACKGROUND OF INVENTION

There are several methods used in intrusion detection systems today. To mention; ultrasound, infrared, microwave, pressure change (volumetric), acoustic detectors and infrasound detectors.

Common for these detection technologies is that as soon as a signal passes a threshold limit, the detector gives a signal and trigs an alarm. This is called peak detection.

It is well known that different technologies may be combined. You then have dual technology or even triple technology, the assumption then is that all of the different technologies shall trig before sending a signal that may cause an alarm.

In the prior art, not much can be found regarding detection principles that may provide information about what cause generates a signal, for instance is it opening of a door or a break in, or what causes the signal. Further, not much has been done previously to provide detection technology that may recognize the actual cause of a signal. Signal in this context means what information does a signal consist of, what does this information tell us and what conclusion may be reached by considering this received information.

There is an invention (“Dual pressure change intrusion detector”) disclosed in U.S. Pat. No. 5,185,593, regarding an arrangement for detecting pressure change. By comparing air pressure inside a perimeter to the pressure outside the perimeter, the detector will sense a breach of a physical barrier or perimeter. When such a breach is sensed, the detector may give a signal and trig an alarm if a protected area is entered.

Another invention (“Glass break sensor having reduced false alarm probability for use within intrusion alarms”) is disclosed in U.S. Pat. No. 5,323,141. This sensor or detector picks up low frequency sound and acoustic high frequency sound. The invention is dedicated to reducing false alarms. Because of huge problems with a microphone that will often become saturated with noise and then trigs false alarms, this microphone is arranged to detect primary acoustic sound as well as a low frequency part of the incoming sound. The sensor will not make a decision to issue an alarm signal until the first received acoustic signal is being completed with a second low frequency signal. This invention will allegedly reduce false alarms significantly for glass break detectors.

The prior art most closely related to the present invention is disclosed in international publication WO 2006/123217 A1 (“System and method for intrusion detection”), belonging to the owner of the present invention. This is an invention related to use of artificial intelligence in signal processing of various incoming signals, with the intent to obtain a reduction of the frequency of false alarms, compared to normal peak or threshold detection. Statistics is used as an important element. If there is divergence between different types of gathered information, a signal or an alarm may be issued, based on the use of an algorithm that treats statistics regarding “normal” and “abnormal” signals recorded during a period. By adapting threshold levels of probability of appearance of pre-defined signal states, it becomes possible to determine a probable cause behind a signal or set of signals. WO 2006/123217 A1 describes also the use of information like signal characteristics and time relations between various signals.

However, the task of finding the cause responsible for a certain composite train of signals picked up by one or several sensors, is a complex task, and there is a need of improving such signal processing methods even further.

### SUMMARY OF THE INVENTION

The present invention is directed to finding the causes behind the incoming signals, in similarity with aspects of WO 2006/123217 A1, but through a different approach.

It is of interest to provide an alarm system that is able to use certain characteristic qualities of incoming sound signals to identify the incidents that have caused or introduced those sound qualities.

In the present invention, the cause behind a signal is identified on the basis of correlation between digitally processed signals in two different detection channels.

Hence, in accordance with the present invention there is provided an intrusion detection system comprising at least one intrusion detector and a processor connected thereto, which intrusion detector has a transducer for picking up gas-borne mechanical vibration energy in a certain frequency range and converting it to electrical vibration energy in the same frequency range, and an ND converter is present in the system in order to provide digital signals representing the electrical vibration energy. The system of the invention is characterized in that the detector furthermore comprises a low-frequency channel for sorting out and supplying to a first input of the processor a low-frequency signal part of said frequency range, as well as a high-frequency channel for sorting out and supplying to a second input of the processor the remaining signal part of said frequency range, and in that the processor comprises circuitry for using certain digital characteristics in the low-frequency signal part and the remaining signal part, respectively, in providing decisions about which incidents have generated the gas-borne mechanical vibration energy. Said processor is provided with means for digitally signal processing the signals provided at its inputs, and the processor further comprises a signal recognition unit in which the digital processed signals are compared with learned and stored signal patterns.

Any one of the detector and the processor may be adapted to split the low-frequency and high-frequency channels further into multiple channels on the basis of high gain filtering, low gain filtering and frequency content.

The A/D converter may be contained in the detector.

The low-frequency channel may be a channel that processes signals in a frequency sub-range of about 1-5 Hz, while the high-frequency channel may be a channel processing signals in a frequency sub-range of about 5-20 Hz. These frequencies are merely examples, however division into a number of frequency ranges is one preferred feature of the invention.

In a preferred embodiment of the invention, the processor circuitry comprises
a comparator for comparing certain digital signal characteristics in the low-frequency signal part to similar digital signal characteristics in the remaining signal part, and for providing a set of comparison result signals to further processor sub-units for further processing, and
among said further processor sub-units, an association sub-unit for establishing association between a comparison result signal and a word to be selected from a word table, and a status sub-unit for establishing a status on the basis of selected words.

It must be realized that in the present context, the meaning of “word” is extended beyond the usual meaning. Herein a “word” may be a natural word, or a sign (for instance a Chinese or Japanese language sign), or even a number.

In one preferred embodiment of the invention, the status sub-unit may further be operative to organize selected words according to a ranking order that is any of pre-defined and natural.

In another embodiment, the association sub-unit may be operative to select automatically, if criteria for a word selection are not met, a word associated with an adjacent comparison result signal that mostly fulfils the criteria. In one embodiment, the comparator is adapted for comparing sequences of incoming energy bursts in the low-frequency signal part to sequences in the remaining signal part.

In another embodiment, the comparator is adapted for comparing durations of incoming energy bursts in the low-frequency signal part to durations in the remaining signal part.

In even another embodiment, the comparator is adapted for comparing time periods between energy bursts in the low-frequency signal part to time periods in the remaining signal part.

In another embodiment, the comparator is adapted for comparing event times of certain signal events, like absolute maximum amplitudes, in energy bursts in the low-frequency signal part to event times in the remaining signal part. In even another embodiment, the comparator is adapted for comparing durations of complete successions of energy bursts in the low-frequency signal part to such durations in the remaining signal part.

In even another embodiment, the comparator is adapted for comparing signal strengths of incoming energy bursts in the low-frequency signal part to signal strengths in the remaining signal part.

In even another embodiment, the comparator is adapted for comparing signal amplitudes in incoming energy bursts in the low-frequency signal part to signal amplitudes in the remaining signal part.

### BRIEF DESCRIPTION OF THE DRAWINGS

In the detailed description following below, the invention will be illuminated better by going through some exemplary embodiments and by referring to the appended drawings, of which

FIG. 1 is a flowchart describing the detection process in accordance with a preferred embodiment of the present invention,

FIG. 2 is a graph showing an analog representation of an infrasound signal picked up with wind as the cause of the signal,

FIG. 3 shows further process stages for the same wind-caused signal as in FIG. 2, in a low-frequency channel,

FIG. 4 shows similar process stages as in FIG. 3, but in a “high-frequency” channel,

FIG. 5 is a graph in which digitally processed signals from the low- and high-frequency channels can be compared or correlated to identify characteristics of the incoming (wind) signal,

FIG. 6 is a bar graph in which the result of the correlation processing appears.

FIG. 7 is an activity chart closely related to the bar graph in FIG. 6, indicating possible activities/incidents, and for setting of such activities that shall result in issuance of an alarm or a signal,

FIGS. 8-13 constitute a sequence of drawings exactly like FIGS. 2-7, however with a break-in incident being the cause of the picked-up signals, and

FIG. 14 shows a basic embodiment of the system of the invention, in a block diagram.

### DETAILED DESCRIPTION OF THE INVENTION

The present invention is dedicated to recognize signals and to characterise signals that occur related to any kind of breach of a physical barrier, like an intrusion, or incidents that may affect the physical construction or structure that encompass a perimeter, or incidents caused by the environment, such as wind, precipitation etc. More particularly, signal “sources” may be any of external noise (machines, traffic etc.), wind, impact, opening/closing of doors/windows, intrusion (break-in, breaking glass or other materials) and any undetermined sound sources. It is of interest to secure a perimeter that may be a building, any kind of vehicle, container, aeroplane, helicopter or eventually other elements that need some kind of securing of a perimeter or area. All incidents that cause a physical change in the environment submit energy, and these changes in the environment and the energy provide certain characteristics in the sound influence on a structure that surrounds a defined area as previously mentioned.

Preferably, information is gathered from infrasound (by some also expressed as pressure or volumetric change) through a microphone/transducer. Infrasound is sound below 20 Hz, and when using infrasound, higher sound frequencies are filtered out. However, the present invention shall not be limited to infrasound, but shall comprise any sound frequency range. By extracting signals from the digital detection process, we are able to recognize and characterize the originally detected signal, and thereby decide the source or cause of the signal.

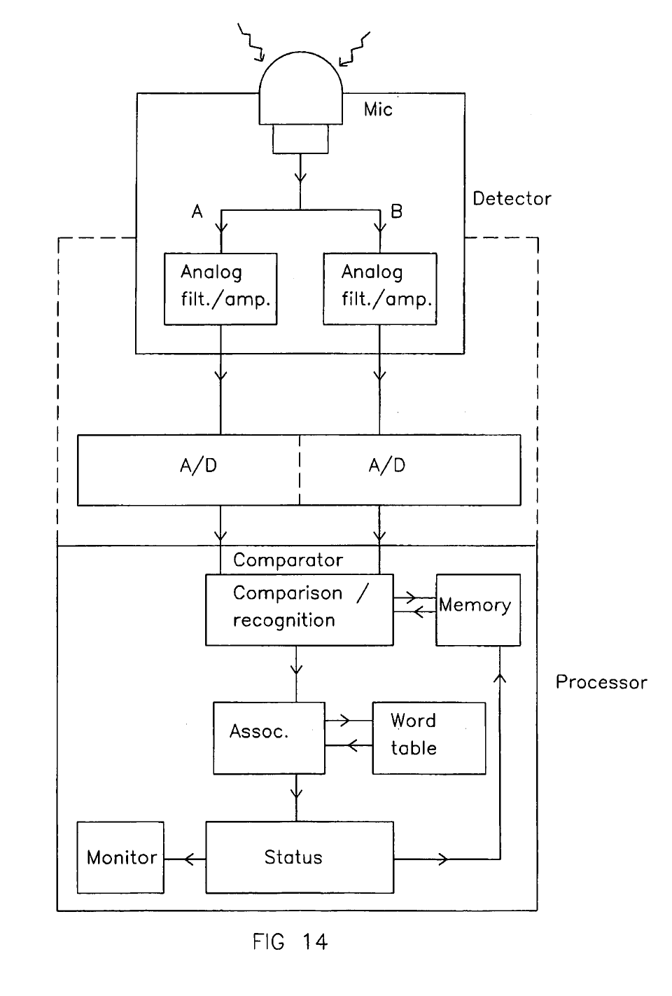

Referring to FIGS. 1 and 14, sound (preferably infrasound) is distributed from the microphone into two channels, channel A and B, which channels are initially divided further into 2 or more sub-channels for processing the signals. Channel A (also named “motion”) typically picks up signals from the frequency range 1-5 Hz, and channel B (also named “impact”) picks up frequencies in the range 5-15 Hz. This distribution is only exemplary and may be adapted for example as channel A 1-7 Hz and channel B 7-15/20 Hz. The signals are at first processed through filtering and amplifying. Channel A divides the signal into low gain and high gain branches, and similarly channel B divides the signal into low gain and high gain branches. The weakest signals in each Channel are thereby amplified to make it possible to work with them.

Then the signals in channel A are assembled into one signal, and the signals in channel B go through a similar process, thereafter both of the Channels (A and B) are converted to digital format by means of A/D converters. There is a possibility to do the digitalizing process immediately after the microphone/transducer or even therein but as of today the most reliable processing of the signal is done as previously described, and further described as follows.

When the digitalization process has been executed, there are two channels that provide each respective digital signal for further processing. In the embodiment shown in FIG. 1, both the low frequency channel (A) and the high frequency channel (B) process signals having a dynamic range 0.02-20 volt peak-to-peak. However, other ranges may be chosen, for instance 0.01-10 volt or 0.01-100 volt. Next, the signals go through a digital signal process (DSP). In the DSP process, various algorithms are used to single out certain pre-defined characteristics of the signals, as exemplified below, and to make comparisons between the two channels regarding the specific characteristics. The process is executed in a comparator part of the processor, and consists inter alia in using parameters like signal strength, duration of signal bursts, duration between signal bursts and duration between occurrence of signal bursts in each respective channel A and B.

Next, signal recognition is executed, for instance by correlating comparison results with previously learned and stored data, and in accordance with special algorithms. In one aspect of the invention the stored data is materialised as an advanced and comprehensive library of sounds. On the basis of such signal recognition processing, a “status” is provided, indicating what type of original sound signal was detected. The lower “boxes” in FIG. 1 show examples of some of the causes that may be identified and set as status. Such “statuses” hence identify whether the original sound signal was caused by noise (for instance passing of a vehicle), wind, fan or air-condition, vibration, precipitation (for instance rain), impact against a door or a window or other structure, opening of a door/window, closing a door/window or a breach of a physical structure (break-in) etc. Some of these statuses/causes may not result in any alarm and are indicated in “plain” boxes, while for instance “Door opened”, “Break” and “Undetermined” will trig an alarm and are indicated in specially marked boxes. It should be noted that for instance “Door opened” does not necessarily need to be a status for trigging an alarm, but in the embodiment shown, parameters have been selected so as to maintain a high degree of security.

The “undetermined” category is a status obtained when for instance a comparison to previously stored data show no reasonable correlation. Such a status will most often be defined as a status justifying an alarm.

“Signal bursts” are defined as incoming “packages” of sound/infrasound energy, between which bursts incoming power lies below a pre-defined or automatically adjustable level.

For example, one may see if a door is opened by detecting a first motion in the “high frequency” range (5-15 Hz), this occurs when the door is unlatched /leaves the doorframe, followed by a slight move (sound) in the lower frequency range (1-5 Hz). On the other hand, if the door is closed, one will detect first a slight move (sound) in the frequency range 1-5 Hz, followed by an impact when the door hits the doorframe (5-15 Hz). Taken to the limit, it should be possible to “hear” and identify a key that turns the key-lock without listening to the sound that we hear, that is higher than 20 Hz, but actually by detecting the infrasound of this action.

The only limitation of doing such detection is how much the low frequencies may be amplified.

The processor contains preferably a memory that stores received digital signals over a period of time and may so recognize previously detected signals and characteristics. This is to be used as information and correlation through the detection process in the system itself and/or as information to a monitoring site to be used when one wishes to identify what kind of activity that has occurred and to what time. It is preferable to put words, signs or numbers on the signals that the detection process has determined. Hence it becomes possible to establish a directive for cases in which an alarm signal shall be trigged, or if the signal should trig any other action to be taken based on the information given. To exemplify this; you may want to know if a door to an area is opened, and you choose to receive a signal “door opens” when the signal process determines this based on the characteristic of this signal, or if you choose “door closes”, when the detection process has confirmed this, the signal is transferred to a display or to a sound source or whatever is dedicated, or may cause an alarm. Or, in some situations there may be benefits in just recording any outer strain like vibration, impact and so, but not to give any signal that leads to an alarm until a decision of an intrusion has been made.

When a comparison result signal has been established by the comparator unit in the processor, this result signal is compared to a stored set of data previously associated with known incident types and associated with a set of words, signs or members (herein generalized as “words”) in a word table. A word associated with the stored data giving the best “match” with comparison result signal, is selected.

If for example duration and frequency parameters of a result signal provide a match against one specific stored set of data, but signal strength does not match, then the signal strength may be given a low priority and a match is determined, as a “mostly fulfilling the criteria” case, i.e. a word is automatically selected that belongs to an “adjacent comparison result signal”.

Some words will be provided as a result of a sequence of signal bursts, or as a result of the splitting of the incoming sound signal into two different channels (low- and “high”-frequency). Such words are then used to provide, finally, the status of the original signal, thereby identifying the cause behind the original signal.

So, stated in another manner, the detection process classifies the signals after the cause has been determined as the criteria have been met. If not all of the criteria are fulfilled, depending on the priority, we may choose to send the signal to the nearest classification that meets the complete required information to make a decision complete.

The processor may, as previously stated, be pre-programmed regarding which signal may be sent to trig an alarm, but may also decide to send a signal to trig an alarm if the activity registered in the form of characteristics and signal recognition deviates from the ongoing characteristics in the area.

It is assumed that especially for commercial sites, it would be of great interest and value to be able to recall and identify signals or causes that have given impact on the area or on any physical structure. This is not limited to activities like intrusion and damaging behaviour. All in all this will provide significant information of causes or events that may impact structures and constructions like buildings etc. This should in addition bring increased value to stakeholders and insurance companies of such sites, and may be prevent unnecessary costs related to activity caused by a second or third party. By employing such a system, this may in many situations constitute an alternative to CCTV, because most of the information gathered will be given without the need of directly “seeing it”.

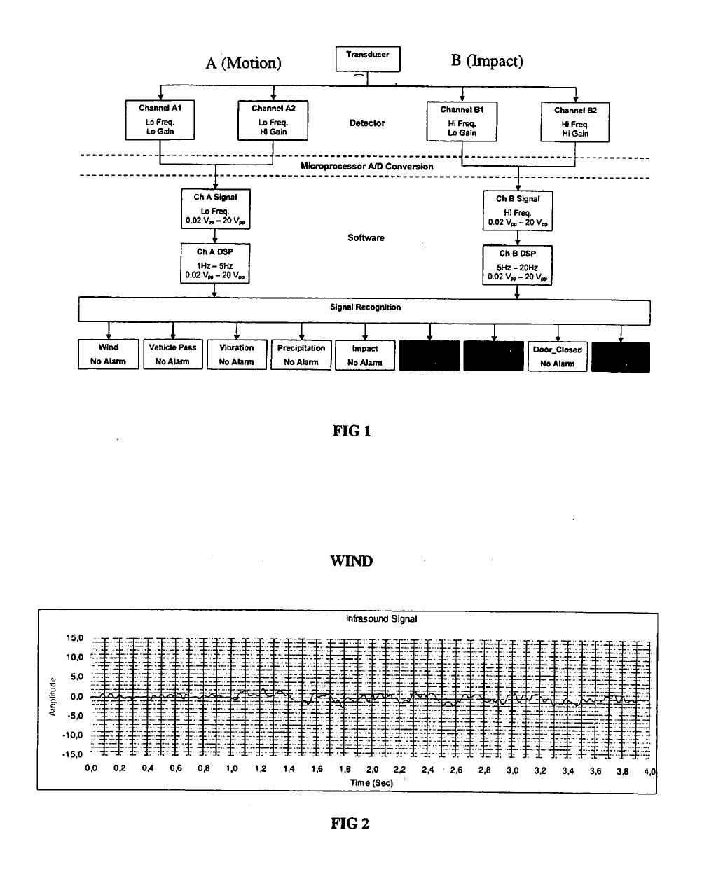

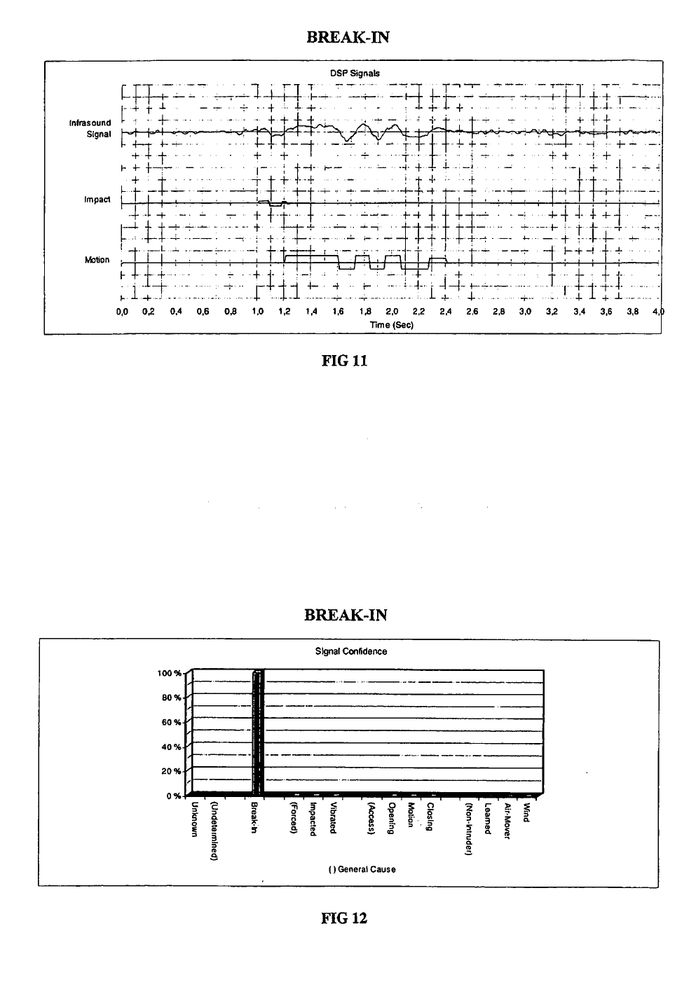

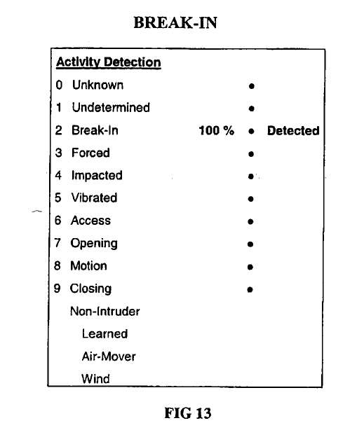

We now take a close look at FIGS. 2-13:

FIG. 2 shows an analog infrasound signal, picked up by the transducer. This particular signal detects an activity caused by wind.

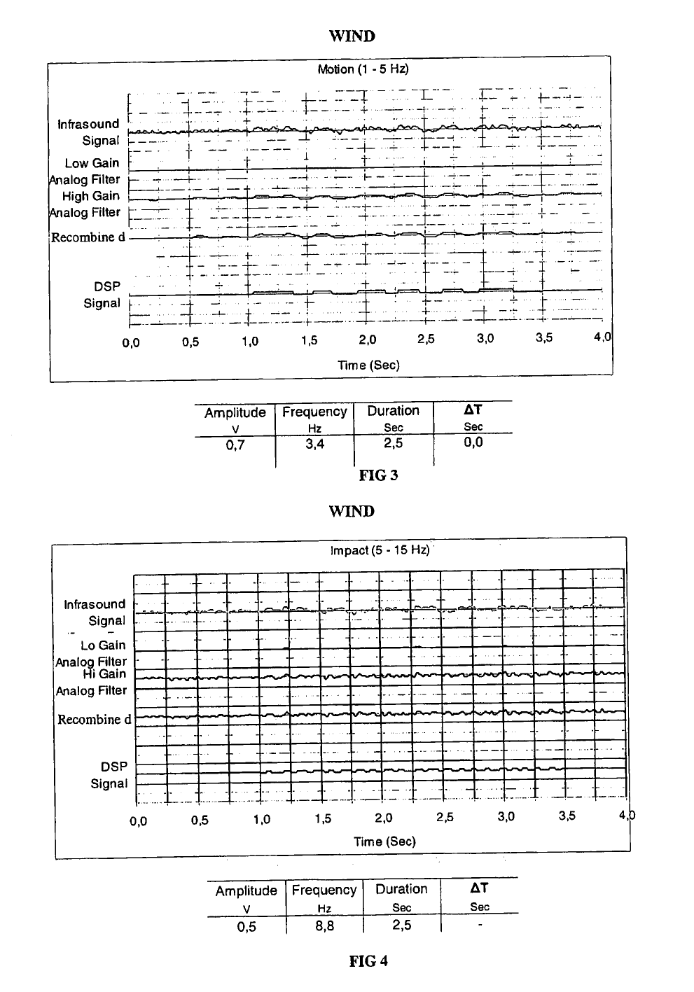

FIG. 3 is a graph that shows Channel A (Low frequency 1-5 Hz) divided into different processing of the signal, starting with the analog signal from FIG. 2, we split the signal, we see Low gain analog filter with no signals, we see the High gain analog filter where we receive signals, we recombine the signals into 1 signal, then we digitalize the signal and we calculate and read the signal frequency, amplitude, duration and starting point. These FIG's also show splitting of the signal into multiple Channels as high/low A and B, and we have a preset offset at for instance 2V to ease the handling of the signals until we automatically adapt to the environment at the site.

FIG. 4 shows a similar process as FIG. 3, but for Channel B (High frequency 5-15 Hz).

FIG. 5 is a graph that shows the digital signal processing (DSP) when the signals from Channel A and Channel B are correlated, and we then see in what Channel the signal first occurred, we see the strength it first occurred with, the time between the signal from Channel A and Channel B, and this enables us to identify the characteristics of the signals. As in this particular signal, we see that there is no time difference between the first signal occurrences in each Channel. We also notice that the amplitude is very low in both Channels, and that it is a long ongoing pattern with no significant changes. The characteristics of an activity will always be the same, but may diverge in strength, i.e. whether a door is opened carefully, normally or roughly it will always start with a higher signal first (when we use most force), followed by a smoother signal. This boils down to how much we amplify the signals.

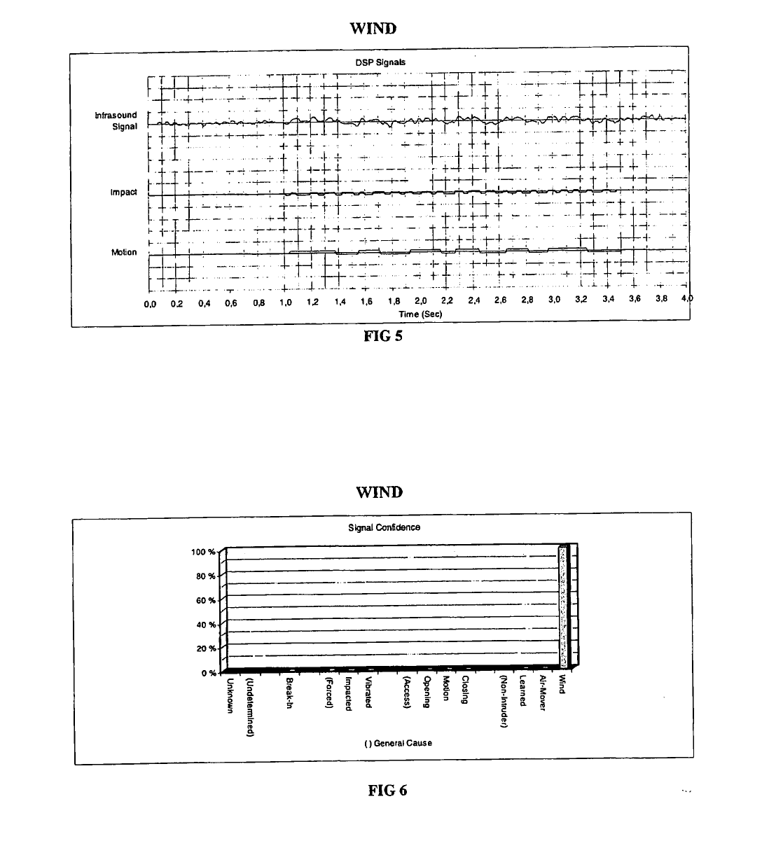

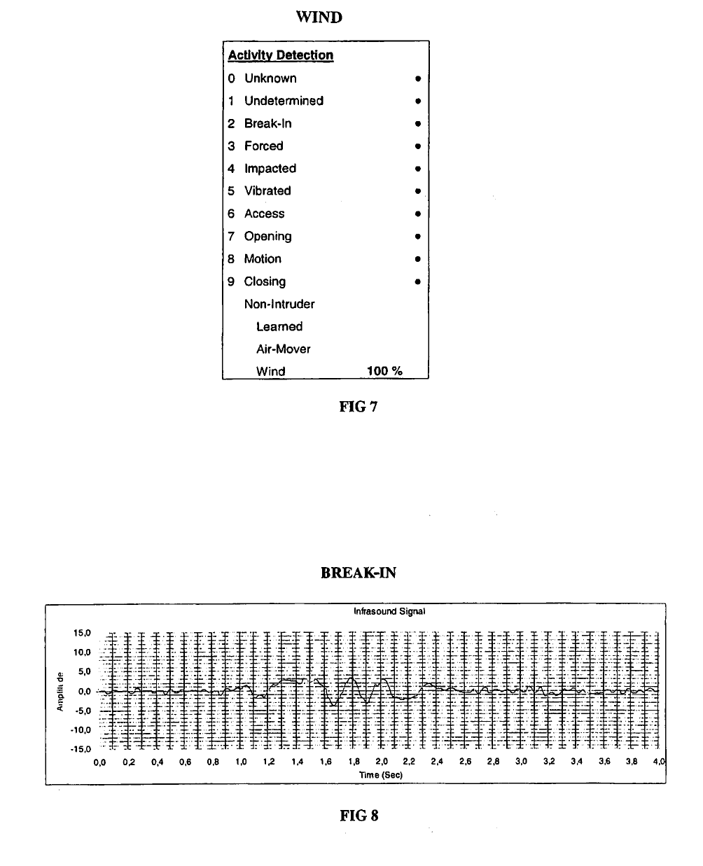

FIG. 6 is a diagram that shows the signal confidence after our calculations, and is a result of detected signals. If we are not confident with our detected signals, the algorithm may automatically choose the nearest decision that fulfils our requirement. Some of the causes stated in the lower part of the figure, are explained herebelow.

FIG. 7 is a chart that displays the activity detected, and where we decide what activity we want to detect, i.e. pre-defining a setting for the detector. This may be transferred through IP lines as words or signals, or we have chosen to only give alarm if any pre settled activity is identified. The figure is also an example of how we may rank causes we would like to detect, in a certain order. The ranking list may be called “Activity concluded”. To mention are activities like “non-intruder” activity that generates so weak signals that we consider this as a non-event. “Learned” are signals that the system recognizes as normal and ongoing activity at the site, based on previously provided detected signals from that particular site, “air-mover” is a motion caused by a fan or air-condition etc. and may not be of interest to follow up with an alarm, “wind” is also a motion that may not be of interest to respond to. If there should be of any interest to react on such events as e.g. air-mover, wind etc. we may chose to do this by activating or enhancing the status of this cause.

FIG. 8 is an analog infrasound signal caused by a break-in (intrusion).

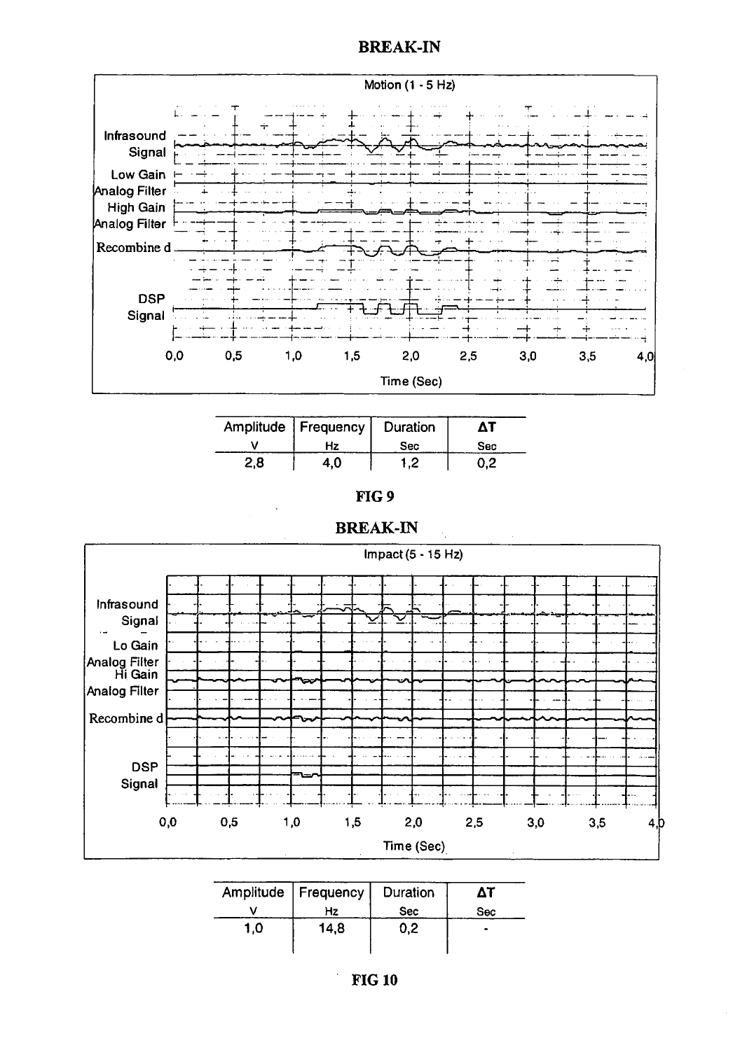

FIG. 9-FIG. 13 show the same process in an intrusion situation as FIG. 1-FIG. 7 did for the wind situation. As the figures show, the signals increase significantly in situations caused by a physical impact. What is of particular notice, is the correlation of Channels A and B, of when the signal occurred, the amplitude of the signals, the frequency range in which the first signal occurred, the duration of the signals and if there are any sequences.

To summarize, the transducer shown as a microphone in FIG. 14, constitutes part of an intrusion detector. There may be more than one such intrusion detector in the system, and the transducers/microphones may be adapted for various frequency ranges, and for various gases, but preferably we are talking about air-borne infrasound vibrations. As depicted in FIG. 14, preferably two ND converters provide digital signals from the electrical signals from the transducer, after the important splitting of the signals into two channels, one low-frequency channel A (as exemplified 1-5 Hz) and one “high-frequency” channel B for the “remaining” signal part of the complete signal range (as exemplified 1-15 Hz). The processor shown in the lower part of FIG. 14 takes care of the “software” and “signal recognition” stages shown in FIG. 1, and comprises circuitry for using digital signal characteristics in the respective “signal parts” to provide decisions about sound-generating incidents. Such circuitry comprises preferably, as exemplified in FIG. 14, a comparator circuit that receives the digital signals from the two channels and processes them further as indicated in the “software” stage of FIG. 1, then compares as exemplified in FIGS. 5 and 11, to provide a set of comparison result signals to an association sub-unit. The comparator may first test the comparison result signals against data stored in a memory, to make the association sub-unit select a suitable word from a word table, to “describe” the result signal. When a short sequence of words has been established in a status sub-unit (see FIG. 14), for instance “door-closing”, a status is established. The status sub-unit is connected to deliver data to the memory unit. Further, a monitoring unit is connected to the status unit, for providing results readable for a user.

It is important to realize, however, that the decisive feature of the present invention is the division of signals from the microphone into low-frequency and high-frequency sub-ranges, thereby providing a special basis for further processing. The further processing may be executed along various principles, but preferably as herein described.

In FIG. 14 we show ND converters as separate elements between the detector and the processor, but they may be included in the detector, or possibly in the processor. As indicated with dotted lines, the processor may for that matter comprise also the analog circuitry for filtering and amplification, but the solid lines indicate the preferred variant.

Typically, the sound frequency range of interest is the infrasound range 1-20 Hz, or possibly only 1-15 Hz. The division point between low and high sub-ranges may be placed anywhere from 3 to 10 Hz, preferably anywhere from 5 to 7 Hz.

As shown in FIGS. 1, 3, 4, 9 and 10, the low- and high-frequency channels may be split further into multiple channels on the basis of signal strength, i.e. different gains are necessary for weak and strong signal parts.

When the status sub-unit as described hereabove receives selected words from the association sub-unit, it establishes a word sequence as previously described, primarily in time succession. But it may also organize a set of words according to a pre-defined ranking order, or use a natural ranking order, for instance according to grammar rules.

When the comparator does its work of comparing characteristics of the signals in the two channels, it may do so in several different approaches. It may for instance compare durations of energy bursts (of simultaneous occurrence) in the two channels, or it may compare time periods passing between energy bursts (of which some are at least approximately simultaneous) in the two channels. Another variant is to compare the exact time points of certain signal units (like maximum amplitudes) in energy bursts (occurring simultaneously) in the two channels, or to compare durations of complete successions of (substantially simultaneous) energy bursts in the two channels. Further, it is possible to compare signal strengths between (substantially simultaneous) signal bursts in the two channels, or to compare signal amplitudes. Generally, sequences of incoming energy bursts in the two channels may be compared.

In a case where a large area is to be protected by several intrusion detectors, it is possible to exploit the physical fact that sound or infrasound generated by a specific local event, will arrive at respective detectors both at different times and with different energy content since sound travels at a definite speed (˜330 m/s) in air and is weakened in relation to propagation distance from its origin.

In one embodiment of the present invention, signals from a set of intrusion detectors will be delivered to a processor unit like in FIG. 14, where such processing as described earlier, is executed for the various detectors, but in addition, further algorithms will be used to exploit the extra information based on “local geography”. Both time differences and signal strength differences between similar signals from different detectors can be used to calculate with a high degree of precision, where the original event took place. One method is of course to use as localization parameter, which detector received the signal first. The event must have occurred in the vicinity of that detector.

Or, in a more advanced version, “triangulation” algorithms may be used to pinpoint even better such an event origin, for example by calculating sound travel times to three different detectors for sound from an event that is identified, through correlation techniques, to be the same event. Such a method may result in a quite accurate position determination of for instance a break-in in progress, and immediate action may be taken.

1. Intrusion detection system comprising at least one intrusion detector and a processor connected thereto, said intrusion detector having a transducer for picking up gas-borne mechanical vibration energy in a certain frequency range and converting it to electrical vibration energy in the same frequency range, an A/D converter being present in said system to provide digital signals representing said electrical vibration energy, said system being characterized in that
said detector furthermore comprises a low-frequency channel for sorting out and supplying to a first input of said processor a low-frequency signal part of said frequency range, as well as a high-frequency channel for sorting out and supplying to a second input of said processor the remaining signal part of said frequency range, said processor is provided with means for digitally signal processing the signals provided at its inputs, and
the processor further comprises a signal recognition unit in which the digital processed signals are compared with learned and stored signal patterns.

2. The intrusion detection system of claim 1,
characterized in that any of said detector and said processor is adapted to split said low-frequency and high-frequency channels further into multiple channels on the basis of high gain filtering, low gain filtering and frequency content.

3. The intrusion detection system of claim 1,
characterized in that said detector contains said A/D converter.

4. The intrusion detection system of claim 1,
characterized in that said low-frequency channel is a channel processing signals in a frequency sub-range of about 1-5 Hz, while said high-frequency channel is a channel processing signals in a frequency sub-range of about 5-20 Hz.

5. The intrusion system of claim 1,
characterized in that said circuitry comprises
a comparator for comparing certain digital signal characteristics in the low-frequency signal part to similar digital signal characteristics in the remaining signal part, and for providing a set of comparison result signals to further processor sub-units for further processing, and
among said further processor sub-units, an association sub-unit for establishing association between a comparison result signal and a word to be selected from a word table, and a status sub-unit for establishing a status on the basis of selected words.

6. The intrusion detection system of claim 5,
characterized in that said status sub-unit is further operative to organize selected words according to a ranking order that is any of pre-defined and natural.

7. The intrusion detection system of claim 5,
characterized in that said association sub-unit is operative to select automatically, if criteria for a word selection are not met, a word associated with an adjacent comparison result signal that mostly fulfil the criteria.

8. The intrusion detection system of claim 5,
characterized in that said comparator is adapted for comparing sequences of incoming energy bursts in the low-frequency signal part to sequences in the remaining signal part.

9. The intrusion detection system of claim 5,
characterized in that said comparator is adapted for comparing durations of incoming energy bursts in the low-frequency signal part to durations in the remaining signal part.

10. The intrusion detection system of claim 5,
characterized in that said comparator is adapted for comparing time periods between energy bursts in the low-frequency signal part to time periods in the remaining signal part.

11. The intrusion detection system of claim 5,
characterized in that said comparator is adapted for comparing event times of certain signal events, like absolute maximum amplitudes, in energy bursts in the low-frequency signal part to event times in the remaining signal part.

12. The intrusion detection system of claim 5,
characterized in that said comparator is adapted for comparing durations of complete successions of energy bursts in the low-frequency signal part to such durations in the remaining signal part.

13. The intrusion detection system of claim 5,
characterized in that said comparator is adapted for comparing signal strengths of incoming energy bursts in the low-frequency signal part to signal strengths in the remaining signal part.

14. The intrusion detection system of claim 5,
characterized in that said comparator is adapted for comparing signal amplitudes in incoming energy bursts in the low-frequency signal part to signal amplitudes in the remaining signal part.
